(19) United States
(12) Patent Application Publication
(10) Pub. No.: US 2010/0085740 A1
(43) Pub. Date: Apr. 8, 2010

(54) BULB-BASED LIGHT STICK

(75) Inventor: Daniel Segel, Schenectady, NY (US)

Correspondence Address: Keohane & D'Alessandro, 1881 Western Avenue, Suite 180, Albany, NY, 12203, US

(73) Assignee: Daniel Segel, Schenectady, NY (US)

(21) Appl. No.: 12/573,094

(22) Filed: Oct. 3, 2009

Related U.S. Application Data
(60) Provisional application No. 61/102,822, filed on Oct. 4, 2008.
(60) Provisional application No. 61/103,393, filed on Oct. 7, 2008.

(51) Int. Cl. F21L 4/00

(52) U.S. Cl. 362/157

(57) ABSTRACT

In general, the present invention generally relates to a bulb-based light stick comprising a vessel that contains an ampule of electrically conductive material (e.g., saline). The base of the vessel contains a circuit assembly that includes at least one battery, electrical contacts, and a light source such as a LED. When the ampule is broken in accordance with known light stick methods, the electrically conductive material fills the vessel and connects a set of electrical contacts. The result is to activate the LED, which illuminates the vessel. As such, the LED can be any color desired.

### CROSS-REFERENCE TO RELATED APPLICATION

This application is related in some aspects and claims the benefit of commonly owned and co-pending application Ser. No. 61/102,822, entitled Bulb-based Light Stick, which was filed on Oct. 4, 2008, the entire contents of which are herein incorporated by reference. This application is application is related in some aspects and claims the benefit of commonly owned and co-pending application Ser. No. 61/103,393, entitled Bulb-based Light Stick, which was filed on Oct. 7, 2008, the entire contents of which are herein incorporated by reference.

### FIELD OF THE INVENTION

This invention generally relates to light sticks. Specifically, this invention relates a bulb-based light stick.

### BACKGROUND OF THE INVENTION

Illuminating structures are well known. These structures have been used to add interest to children's toys and jewelry, create items for temporary lighting, and even as fishing lures. The use of chemiluminescent chemicals is one common method of creating an illuminating structure and is well known in the art. In these devices, a semi-translucent tube contains two chemicals. The mixture of the two chemicals creates a temporary lighting effect. To prevent the chemicals from mixing prematurely, the tube is filled with one of the chemicals, and ampules (frequently glass or plastic) that contain the second chemical are inserted into the tube. A user can then break the ampule to allow the chemicals to mix, generating the luminescent effect. Depending on the chemicals used, color of the tube, etc. different colors can be created. Various combinations of chemicals can be used to obtain a desired color and are discussed, for example, in U.S. Pat. No. 4,061,910 issued on Dec. 6, 1977. Unfortunately, chemicals only pose environmental and safety problems, but also longevity problems. As such, a need for an alternative exists.

### SUMMARY OF THE INVENTION

In general, the present invention generally relates to a bulb-based light stick comprising a vessel that contains an ampule of electrically conductive material (e.g., saline). The base of the vessel contains a circuit assembly that includes at least one battery, electrical contacts, and a light source such as a LED. When the ampule is broken in accordance with known light stick methods, the electrically conductive material fills the vessel and connects a set of electrical contacts. The result is to activate the LED, which illuminates the vessel. As such, the LED can be any color desired.

A first aspect of the present invention provides a bulb-based light stick comprising: a vessel containing a breakable ampule having electrically conductive material; and a circuit assembly connected to a bulb, wherein the electrically conductive material caused completes causes the bulb to illuminate when the ampule is broken.

### BRIEF DESCRIPTION OF THE DRAWINGS

These and other features of this invention will be more readily understood from the following detailed description of the various aspects of the invention taken in conjunction with the accompanying drawings in which:

FIG. 1 shows bulb-based light stick according to the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DESCRIPTION OF THE INVENTION

The present invention generally relates to a bulb-based light stick comprising a vessel that contains an ampule of electrically conductive material (e.g., saline). The base of the vessel contains a circuit assembly that includes at least one battery, electrical contacts, and a light source such as a LED. When the ampule is broken in accordance with known light stick methods, the electrically conductive material fills the vessel and connects a set of electrical contacts. The result is to activate the LED, which illuminates the vessel. As such, the LED can be any color desired.

The attached depicts an illustrative device according to the present invention. As mentioned above, the device comprises a vessel containing a liquid filled ampule. The liquid is typically electrically conductive. When the ampule is broken, the electrically conductive liquid contacts/connects the electrical contacts, which engages the battery-powered circuit assembly. The result is that the light source (e.g., the LED) to turn on an illuminate the light stick. The color can be based on the color of the LED and/or the color of the liquid in the ampule. If it is desired to turn off the light stick, the vessel can be turned upside down so that the circuit assembly is facing upwards. This can cause the liquid to fall out of contact with the electrical contacts and thus, turn off the LED ands conserving the battery.

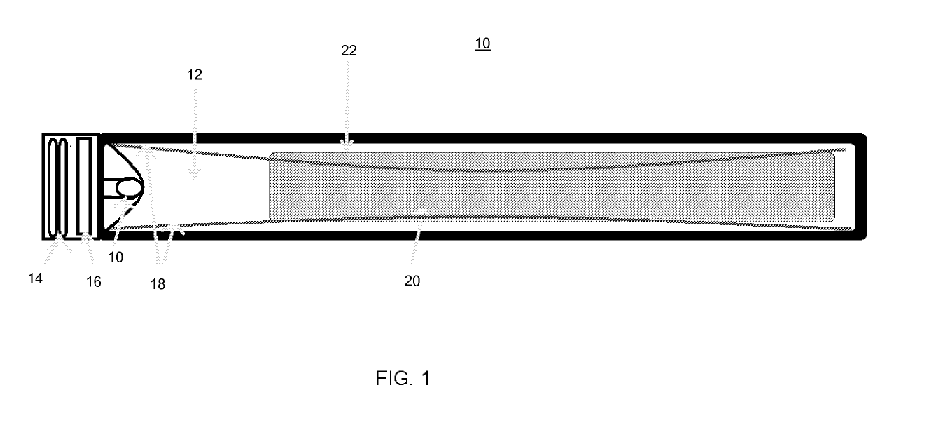

The inside of the vessel becomes a mixing chamber when the ampule is broken. As shown in the attached FIG. 1, bulb-based light stick 10 generally includes at least the following components: mixing chamber 12, battery 14, circuit assembly 16, light (e.g., a light emitting diode) 18, electroconductive material 20, and ampule 22.

In one embodiment, mixing chamber 12 comprises sensors, probes, contacts or wires 20 (e.g., at least two) that will allow device 10 to be activated when ampule contents are released. Depending on the configuration it may be possible to turn device 10 off if positioned in a way to break the circuit that causes activation. Sensors/contacts 20 are typically made of a material, preferably of metal that have conductive properties. The Integrated Circuit/assembly and/or processor 16 can contain any type of circuit, each for a specific function, such as sensing the circuit then activating a light source, the IC is also capable of causing the light source to change color, blink or flash, or just stay constantly lit. The circuit assembly 16 receives power from at least one battery 14, which are preferably lithium, and are hooked up in series or parallel depending on the needs of the circuit, to provide power to an illuminate light 18. The device is ideal for safety devices, LED based glow sticks as it can be designed to be made waterproof and can be used under extreme conditions. It can also be incorporated into any electronic device as a method of guaranteed activation to prevent accidental activation, even products that do not use or contain a light source such as a transponder or transceiver.

It should be understood that ampule 22 can contain any material (solid liquid or gas) that is electrically conductive 20. In addition, circuit assembly can be any known type of circuit assembly that is capable of turning on a light source such as a LED. Still yet, the light 18 utilized need not be an LED, rather it could be any type of light source now known or later developed. These and other details/definitions, and/or alternatives are further given below:

Ampule—purpose is to contain a substance that is used to complete the circuit when released into the mixing chamber when broken.

Other Activation Methods
(A) A magnetic device can be released when the vessel is bent that will complete a circuit when connected. This magnetic device need not be contained in the ampule.
(B) Spring loaded mechanism that is deployed to complete the circuit when the vessel is bent

An object such as a ball bearing (be-be) using g-forces and or pressure to activate one of the above mentioned. With this, an ice cube or other device can be created that is activated with a ball barring. In addition, a small module that can be built into our products that often activate unintentionally.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

I claim:

1. A bulb-based light stick comprising:
a vessel containing a breakable ampule having electrically conductive material; and
a circuit assembly connected to a bulb, wherein the electrically conductive material caused completes causes the bulb to illuminate when the ampule is broken.

2. The bulb-based light stick of claim 1, the bulb being a light emitting diode (LED).

3. The bulb-based light stick of claim 1, the circuit assembly comprising a set of electrical contacts that extends into the vessel, the set of contacts being laced in electrical contact with one another via the electrically conductive material when the ampule is broken.
